(19) United States
(12) Patent Application Publication
(10) Pub. No.: US 2012/0239723 A1
(43) Pub. Date: Sep. 20, 2012

(54) COMMUNICATION SYSTEM AND METHOD OF CONTROLLING THE SYSTEM

(75) Inventors: Toshiyuki Noguchi, Tokyo (JP); Satoshi Igeta, Kawasaki-shi (JP)

(73) Assignee: CANON KABUSHIKI KAISHA, Tokyo (JP)

(21) Appl. No.: 13/409,579

(22) Filed: Mar. 1, 2012

(30) Foreign Application Priority Data
Mar. 15, 2011 (JP) 2011-057093
Feb. 20, 2012 (JP) 2012-034535

(51) Int. Cl. G06F 15/16

(52) U.S. Cl. 709/201

(57) ABSTRACT

A transmission device registers first cooperation information relating to cooperative processing in a cooperative control apparatus along with a transmission code relating to the cooperative processing, and notifies the transmission code to a response device. The response device thereby acquires the first cooperation information associated with the transmission code, and returns a reply code to the transmission device. The transmission device acquires second cooperation information associated with the reply code from the cooperative control apparatus, and, in the case where response device identification information included in the second cooperation information corresponds to the stored response device information, sets the response device as a device with which to perform cooperative processing.

### BACKGROUND OF THE INVENTION

1. Field of the Invention

The present invention relates to technology for performing processing cooperatively between a transmission device and a response device.

2. Description of the Related Art

A technique has been proposed in which a transmission device displays a transmission code computed using a random number and broadcasts that transmission code via radio waves. A response device that receives the transmission code sends an input code that has been input on the response device to the transmission device when the input code matches the received transmission code. When the input code thus received by the transmission device matches the transmission code of the transmission device, the transmission device and the response device perform processing cooperatively (see Japanese Patent Laid-Open No. 2008-211706).

When a transmission code is notified via broadcast as mentioned above in the case of notifying information for cooperating with a device in a remote location, it is not possible to reliably notify only the remote device with which it is intended to cooperate. Thus, there is a problem in that even if a transmission code is, for example, input mistakenly or for an ulterior purpose on a device that has received the transmission code, there was no way of checking whether the device is the remote device with which it is intended to cooperate, and so the transmission device could end up cooperating with an unintended device.

The method according to the above Japanese Patent Laid-Open No. 2008-211706 cannot address the case where the transmission device wants to cooperate with a device that is beyond the range of radio waves. Even within the range of the radio waves, because the transmission code is broadcast, the operation for cooperating could possibly be performed simultaneously with a plurality of devices that are within the range of the radio waves. Therefore, the transmission device could possibly end up cooperating with an unintended device due to the transmission code being input mistakenly or for an ulterior purpose.

### SUMMARY OF THE INVENTION

An aspect of the present invention is to eliminate the above problems in the conventional technology.

The features of the present invention can provide technology that enables a transmission device and a response device that are specified by cooperative processing to reliably perform processing cooperatively.

According to an aspect of the present invention, there is provided a communication system comprising a transmission device, a response device and a cooperative control apparatus for controlling cooperative processing between the transmission device and the response device, wherein the transmission device comprising: a storage unit configured to store response device information related to cooperative processing with the transmission device; a first register unit configured to register, in the cooperative control apparatus along with a transmission code relating to the cooperative processing, first cooperation information relating to the cooperative processing; a notification unit configured to notify the transmission code to the response device; a first acquisition unit configured to acquire, from the cooperative control apparatus, second cooperation information associated with a reply code received from the response device; and a first setting unit configured to set the response device specified by response device identification information included in the second cooperation information as a device with which to perform the cooperative processing, in a case where the response device identification information included in the second cooperation information corresponds to the response device information stored in the storage unit, and wherein the response device comprising: a second acquisition unit configured to acquire, from the cooperative control apparatus, the first cooperation information associated with the transmission code; a second register unit configured to register, in the cooperative control apparatus along with the reply code relating to the cooperative processing, the second cooperation information relating to the cooperative processing; and a second setting unit configured to request the cooperative control apparatus to authenticate the transmission device specified by the first cooperation information, and, if successfully authenticated, sets the transmission device specified by the first cooperation information as a device with which to perform the cooperative processing.

According to another aspect of the present invention, there is provided a method of controlling a communication system that includes a transmission device, a response device and a cooperative control apparatus for controlling cooperative processing between the transmission device and the response device, comprising the steps of: registering, for the transmission device, in the cooperative control apparatus along with a transmission code relating to the cooperative processing, first cooperation information relating to the cooperative processing; notifying, for the transmission device, the transmission code to the response device; acquiring, for the transmission device, from the cooperative control apparatus, second cooperation information associated with a reply code received from the response device; setting, for the transmission device, the response device specified by response device identification information included in the second cooperation information as a device with which to perform the cooperative processing, in a case where the response device identification information included in the second cooperation information corresponds to response device information stored in the transmission device; acquiring, for the response device, from the cooperative control apparatus, the first cooperation information associated with the transmission code; registering, for the response device, in the cooperative control apparatus along with the reply code relating to the cooperative processing, the second cooperation information relating to the cooperative processing; and requesting, for the response device, the cooperative control apparatus to authenticate the transmission device specified by the first cooperation information, and, if successfully authenticated, setting the transmission device specified by the first cooperation information as a device with which to perform the cooperative processing.

Further features and aspects of the present invention will become apparent from the following description of exemplary embodiments with reference to the attached drawings.

### BRIEF DESCRIPTION OF THE DRAWINGS

The accompanying drawings, that are incorporated in and constitute a part of the specification, illustrate embodiments of the invention and, together with the description, serve to explain the principles of the invention.

FIG. 1 is a block diagram for illustrating an exemplary configuration of a communication system utilizing a cooperative control apparatus according to an embodiment of the present invention.

FIGS. 2A to 2C are diagrams showing exemplary data configurations of a transmission code and a reply code managed by the cooperative control apparatus.

FIG. 3 is a diagram showing an exemplary data configuration of authentication information managed by the cooperative control apparatus.

FIGS. 4A and 4B are diagrams showing exemplary data configurations for a transmission device to manage a response device according to the present embodiment.

FIG. 5 is a diagram showing an exemplary data configuration for a response device to manage a transmission device according to the present embodiment.

FIGS. 6A to 6C are flowcharts for describing the data flow in the communication system according to the present embodiment.

FIGS. 6D to 6E are flowcharts for describing the data flow in the communication system according to another embodiment of the present invention.

FIGS. 7A to 7D are diagrams showing exemplary screens for setting a response device that are displayed on the transmission device of the present embodiment.

FIGS. 8A and 8B are diagrams showing exemplary screens for setting a transmission device in a response device according to the present embodiment.

FIG. 9 is a diagram showing exemplary processing utilizing email in the communication system according to the present embodiment.

### DESCRIPTION OF THE EMBODIMENTS

Embodiments of the present invention are described hereinafter in detail, with reference to the accompanying drawings. It is to be understood that the following embodiments are not intended to limit the claims of the present invention, and that not all of the combinations of the aspects that are described according to the following embodiments are necessarily required with respect to the means to solve the problems according to the present invention.

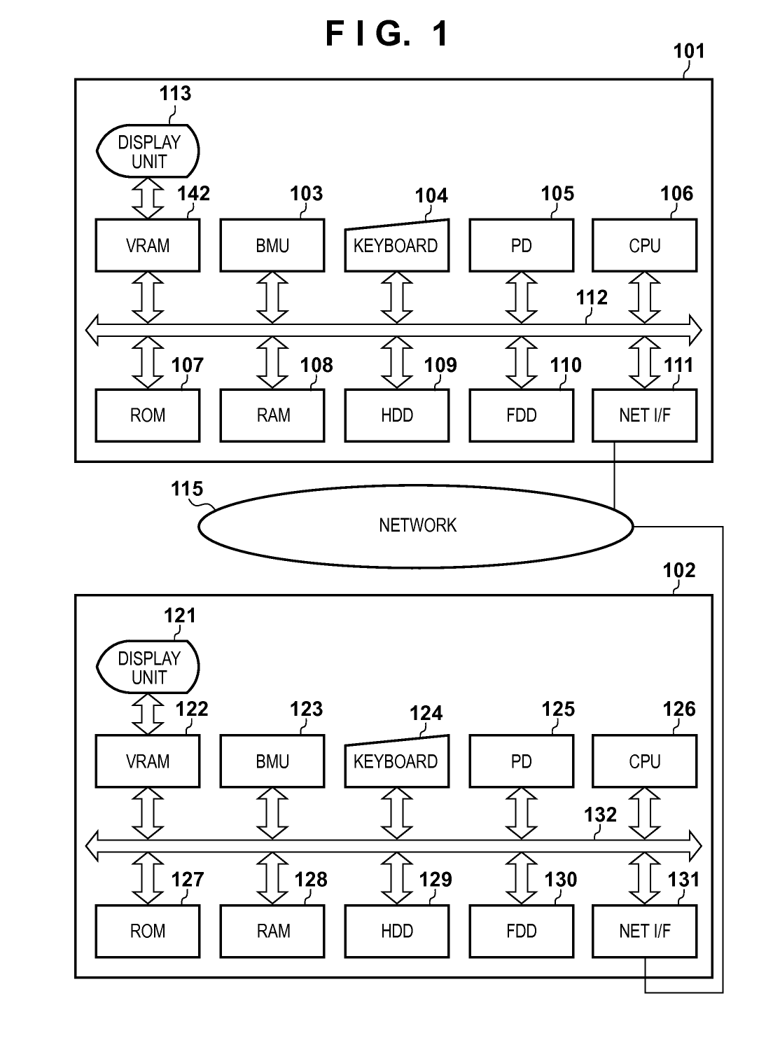

FIG. 1 is a block diagram for illustrating an exemplary configuration of a communication system utilizing a cooperative control apparatus according to an embodiment of the present invention.

A cooperative control apparatus 101 according to the present embodiment is connected, through a network 115, to a user device 102A that transmits information for cooperating with a device in a remote location and a user device 102B that responds to the transmitted information. Note that, in FIG. 1, these user devices (information processing apparatuses) 102A and 102B are collectively referred to as user device 102. Also, in the following description, matters common to both user devices 102A and 102B are described in terms of the user device 102.

The user device 102, by operating a program having a standard protocol enabling information to be conveyed through the network 115, accesses the cooperative control apparatus 101 using a protocol such as HTTP and sends information created in a description language such as XML. Also, information created in a description language such as HTML or XML is received from the cooperative control apparatus 101 and analyzed, and the information can be displayed on a display unit 121 based on that analysis result or used to respond to a user. A user who wants to cooperate with another device executes a program A in the user device 102A. Also, the user who wants to cooperate with another device notifies a transmission code displayed on the user device 102A to a user of the device that he or she wants to cooperate with. Note that, in the present embodiment, notification may be by way of e-mail, telephone or the like, with any method of communication being acceptable.

The way in which the user device 102A utilizes the cooperative control apparatus 101 to acquire a transmission code is discussed later. The user of the user device 102B thus notified of the transmission code executes a program B on the user device 102B. The user of the user device 102B then inputs the notified transmission code in accordance with instructions from the user device 102B. Next, the user of the user device 102B notifies a reply code displayed on the user device 102B to the user of the user device 102A who notified the transmission code. Note that, in the present embodiment, the reply code may be notified to the user who notified that transmission code by way of e-mail, telephone or the like, with any method of communication being acceptable. Note that processing of a transmission code and acquisition of a reply code by the user device 102B utilizing the cooperative control apparatus 101 are discussed later.

When the user of the user device 102A that wants to cooperate thereby receives notification of that reply code, he or she executes the program A on the user device 102A, and inputs the notified reply code in accordance with instructions from the user device 102A.

The user device 102A thereby compares device identification information of a transmission device notified by that reply code with device identification information of the user device 102A, based on the input reply code. If they are the same, it is judged that the reply code is from the device with which the user wants to cooperate, and processing is performed. Note that processing of the reply code by the user device 102A utilizing the cooperative control apparatus 101 is discussed later.

This enables information for performing processing cooperatively with a device in a remote location to be reliably notified utilizing the cooperative control apparatus 101. Note that while an example in which processing is executed by the user device 102 and a program thereof is described as an embodiment for convenience of description, the user device may be a general-purpose device such as a PC, a dedicated device such as a camera, or an information processing apparatus that executes a general-purpose application.

Also, the data may be sent and received after undergoing encryption such as SSL (Source Socket Layer) encryption when data for cooperating is sent and received through the network 115. Further, because data for cooperating is sent and received through the network 115, a configuration may be adopted that enables data to only be sent and received by approved information processing apparatuses.

In FIG. 1, the cooperative control apparatus 101 has a display unit 113, a VRAM 142, a BMU 103, a keyboard 104, a PD 105, a CPU 106, a ROM 107, a RAM 108, an HDD 109, an FDD 110, a network I/F 111, and a bus 112. Icons, messages, menus and other user interface information for managing the cooperative control apparatus 101, for example, are displayed on the display unit 113. Images for displaying on the display unit 113 are rendered in the VRAM 142. Image data developed in this VRAM 142 is transferred to the display unit 113 in accordance with a prescribed regulation, and an image is thereby displayed on the display unit 113. The BMU (bit move unit) 103 controls data transfer between memories (e.g., between the VRAM 142 and another memory), and data transfer between a memory and each I/O device (e.g., network I/F 111). The keyboard 104 has various keys for inputting characters and the like. The PD (pointing device) 105 is used, for example, for indicating icons, menus and other contents displayed on the display unit 113 or for dragging and dropping objects.

The CPU 106 controls the devices based on an OS stored in the ROM 107, the HDD 109 or the FDD 110 and control programs such as programs for saving cooperation data discussed later. The ROM 107 saves various control programs and data. The RAM 108 has a work area for the CPU 106, a save area for data at the time of error processing, a load area for control programs, and the like. The HDD 109 stores data such as control programs executed by the cooperative control apparatus 101 and temporarily data. The network I/F 111 communicates with other information processing apparatuses, printers and the like through the network 115. The FDD 110 is a flexible disk drive. The bus 112 includes an address bus, a data bus, and a control bus. Note that the control programs of the CPU 106 may be developed in the RAM 108 from the ROM 107, the HDD 109 or the FDD 110, or may be developed in the RAM 108 from another information processing apparatus via a network through a network I/F 111.

The basic hardware configuration of the user device 102 is the same as the above-mentioned cooperative control apparatus 101. That is, the user device 102 has a display unit 121, a VRAM 122, a BMU 123, a keyboard 124, a PD 125, a CPU 126, a ROM 127, a RAM 128, a HDD 129, a FDD 130, a network I/F 131, and a bus 132. Since the operations of these units are basically the same as the corresponding units of the cooperative control apparatus 101 and the control programs stored by the HDD 129 and the ROM 127 differ, description thereof is omitted.

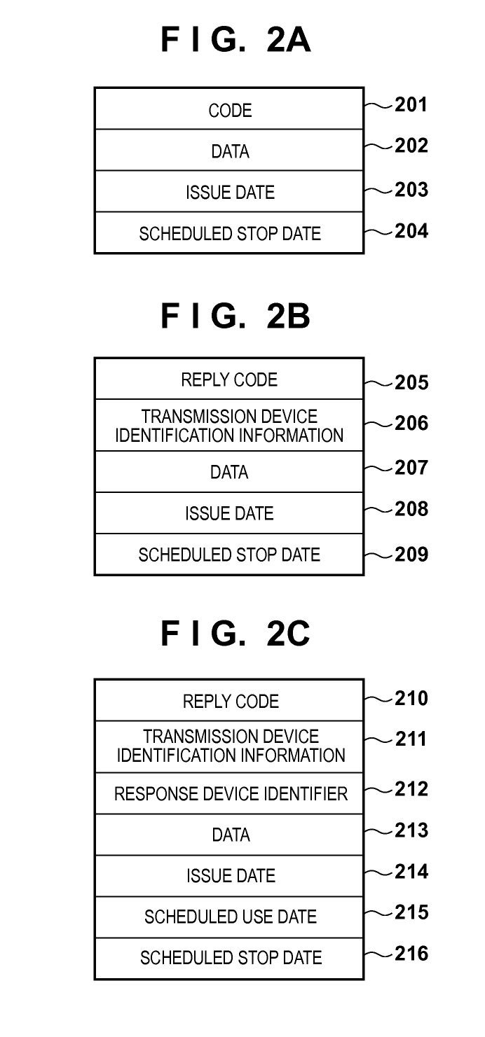

FIG. 2A to FIG. 2C are diagrams showing exemplary data configurations of a transmission code and a reply code managed by the cooperative control apparatus 101 according to the present embodiment.

FIG. 2A shows an exemplary data configuration related to a transmission code or a reply code issued by the cooperative control apparatus 101.

A code 201 is a code for a user to acquire data received and saved by the cooperative control apparatus 101. This code 201, which is unique to the cooperative control apparatus 101, is constituted by only numbers or by characters and numbers and is usable as either a transmission code or a reply code. The code 201 can be used to acquire data within the period up to a scheduled stop date 204, and in the case where the date indicated by the scheduled stop date 204 has passed, the value of the code 201 can be associated with other data and reused.

Data 202 saves data to be notified to a device in a remote location that is received by the cooperative control apparatus 101 when issuing a transmission code or a reply code. Although the actual data 202 is directly saved and managed in the present embodiment, this data may be saved in a file and the file path may be set in the data 202. Also, the contents of this data are not limited.

An issue date 203 indicates the date on which the cooperative control apparatus 101 received and saved the data and issued the code 201. The scheduled stop date 204 is a date obtained by adding the period for which the data is valid to the issue date 203. For example, in the case where the issue date is “00:00:00, Jan. 1, 2010” and the validity period of the code 201 is 14 days, the scheduled stop date is set as “00:00:00, Jan. 15, 2010”. Note that the validity period may be stored instead of the scheduled stop date 204.

FIG. 2B is a diagram showing an exemplary data configuration provided with a structure for shortening a reply code managed by the cooperative control apparatus 101.

A reply code 205 is a code for a user to acquire data that has been received and saved by the cooperative control apparatus 101. This reply code 205 is unique to the cooperative control apparatus 101 and transmission device identification information 206, and is constituted by only numbers or by characters and numbers. This reply code 205 can be used to acquire data within the period up to a scheduled stop date 209, and in the case where the date indicated by the scheduled stop date 209 has passed, the value of this reply code 205 is associated with other data and reused. The transmission device identification information 206 is identification information of the transmission device with which association is requested when issuing the reply code 205. This transmission device identification information 206 is identification information of the transmission device that is notified to the response device with the transmission code. Note that this identification information is unique to the cooperative control apparatus 101, and, although not illustrated, may be information that is generated and set by the cooperative control apparatus 101. This identification information may alternatively be a unique device number set at the factory or the like that is not duplicated, and is not particularly limited. Data 207 saves data to be notified to a device in a remote location that is received by the cooperative control apparatus 101 when issuing the reply code 205. Note that although the data 207 directly saves and manages actual data in the present embodiment, the data may be saved in a file and the file path of the file may be stored in the data 207. Also, the contents of this data are not limited.

In the present embodiment, because the data 207 is managed with the reply code 205 and the transmission device identification information 206, the reply code 205 can be generated with fewer characters compared with the code 201 of FIG. 2A. An issue date 208 is the date on which the cooperative control apparatus 101 received and saved the data and issued the reply code 205. The scheduled stop date 209 is a date obtained by adding the period for which that data is valid to the issue date 208. For example, in the case where the issue date 208 is “00:00:00, Jan. 1, 2010” and the validity period of the reply code 205 is 14 days, the scheduled stop date 209 is set as “00:00:00, Jan. 15, 2010”. Note that because the issue date 208 is held, the validity period may be held instead of the scheduled stop date.

FIG. 2C is a diagram showing an exemplary data configuration provided with a structure for displaying a reply code on a transmission device.

A reply code 210 is a code for a user to acquire data that has been received and saved by the cooperative control apparatus 101. This reply code 210 is unique to the cooperative control apparatus 101 and transmission device identification information 211, and is constituted by only numbers or by characters and numbers. The reply code 210 can be acquired within the period up to a scheduled use date 215 as a reply code list associated with the transmission device identification information 211. This reply code 210 can be used to acquire data within the period up to a scheduled stop date 216, and in the case where the date indicated by the scheduled stop date 216 has passed, the value of this reply code 210 is associated with other data and reused.

The transmission device identification information 211 is identification information of the transmission device with which association is requested when issuing the reply code 210. The transmission device identification information 211 is identification information of the transmission device that is notified to the response device with the transmission code, and response device identification information 212 is identification information of the response device that is issued by the transmission device. Note that this transmission device identification information 211 is unique to the cooperative control apparatus 101, and, although not illustrated, may be information that is generated and set by the cooperative control apparatus 101. This identification information 211 may alternatively be a unique device number set at the factory or the like that is not duplicated, and is not particularly limited. Data 213 saves data to be notified to a device in a remote location that is received by the cooperative control apparatus 101 when issuing the reply code 210. Note that although the data 213 directly saves and manages actual data in the present embodiment, the data may be saved in a file and the file path of the file may be stored in the data 213. Also, the contents of this data are not limited. An issue date 214 is the date on which the cooperative control apparatus 101 received and saved the data and issued the reply code 210. The scheduled stop date 216 is a date obtained by adding the period for which that data is valid to the issue date 214.

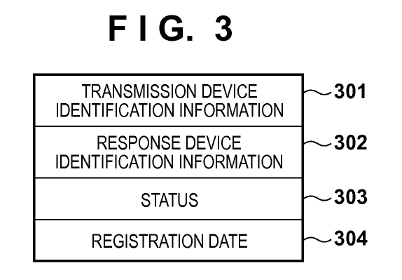

FIG. 3 is a diagram showing an exemplary data configuration of authentication information managed by the cooperative control apparatus 101 according to the present embodiment.

Transmission device identification information 301 is identification information of a transmission device that has performed authentication. Response device identification information 302 is identification information of a response device that has performed authentication. Authentication information includes the transmission device identification information 301 and the response device identification information 302, and these pieces of information are unique within the cooperative control apparatus 101. A status 303 is the status of the authentication information, and has states such as “authenticated” and “failure”. A registration date 304 is the date on which the authentication information was received by the cooperative control apparatus 101.

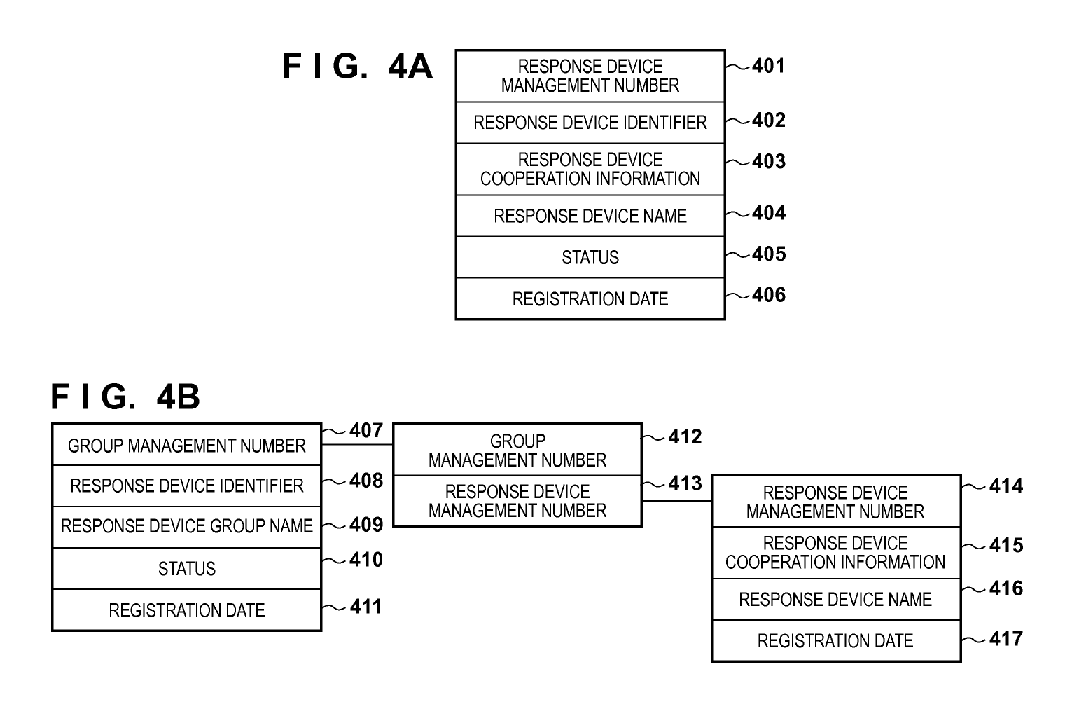

FIGS. 4A and 4B are diagrams showing exemplary data configurations for a transmission device to manage a response device according to the present embodiment.

FIG. 4A shows an exemplary data configuration in the case of notifying a single transmission code from the transmission device to a single response device.

A response device management number 401 is a management number of a response device for the transmission device to manage data of the response device, and a unique number within the transmission device is allocated when a transmission code is acquired. A response device identifier 402 is an identifier of the response device that is added to data for cooperation and notified to the response device with the transmission code, and a unique identifier within the transmission device is allocated when the transmission code is acquired. Response device cooperation information 403 is information for cooperating with the response device that is sent from the response device to the transmission device with the reply code. This cooperation information is data required in order to perform cooperation such as account data constituted by a user ID and a password, for example, or an IP address, approved URL or the like, and the contents of this data are not limited. A response device name 404 is name information of the response device that consists of a character string, an image or the like for the user of the transmission device to recognize the response device. A status 405 represents a state of the management data of the response device such as “provisional registration” or “registered”. A registration date 406 indicates the date on which the management data was registered.

FIG. 4B is a diagram showing an exemplary data configuration for notifying a single transmission code to a plurality of response devices from the transmission device, and managing the plurality of response devices as a group.

A group management number 407 is a number for the transmission device to manage the group of response devices, and a unique number in that transmission device is allocated when the transmission code is acquired. A response device identifier 408 is an identifier that is added to data for cooperation and notified to the response devices, and a unique identifier in the transmission device is allocated when the transmission code is acquired. A response device group name 409 is information such as a character string or an image for the user of the transmission device to recognize the group of response devices. A status 410 has states such as “provisional registration” and “registered”. A registration date 411 indicates the date on which the data was registered.

A group management number 412 is a group management number associated with a response device management number 413, and is the same as the abovementioned group management number 407.

The response device management number 413 is a management number for managing the data of each response device on the transmission device, and a unique number in the transmission device is allocated when a reply code is processed and authenticated.

A response device management number 414 is the same as the response device management number 413. Response device cooperation information 415 is information for cooperating with each response device that is sent from the response device to the transmission device with the reply code. This cooperation information is data required in order to perform cooperation such as account data constituted by a user ID and a password, or an IP address, approved URL or the like, and the contents of this data are not particularly limited in the present embodiment. A response device name 416 is name information of each response device that consists of a character string, an image or the like for recognizing the response device. A registration date 417 is the date on which the data of each response device was registered.

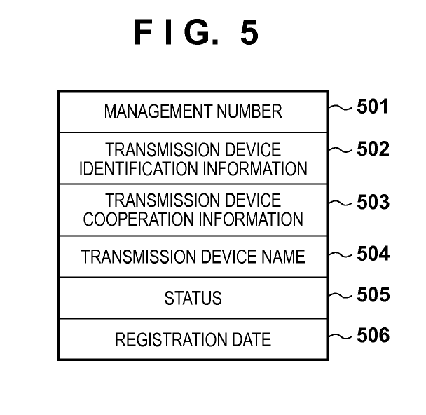

FIG. 5 is a diagram showing an exemplary configuration of data for a response device to manage a transmission device according to the present embodiment.

A management number 501 is a management number for the response device to manage data of the transmission device, and a unique number in the response device is allocated when processing a transmission code. Transmission device identification information 502 is device identification information of the transmission device that is notified from the transmission device to the response device by the transmission code. Transmission device cooperation information 503 is information for cooperating with the transmission device that is notified from the transmission device to the response device by the transmission code. This cooperation information is data required in order to perform cooperation, such as account data constituted by a user ID and a password, or an IP address, an approved URL or the like, and the contents of this data are not particularly limited. A transmission device name 504 is information indicating a name of the transmission device that consists of a character string, an image or the like for recognizing the transmission device. A status 505 has states such as “provisional registration” and “registered”. A registration date 506 is the date on which the data was registered.

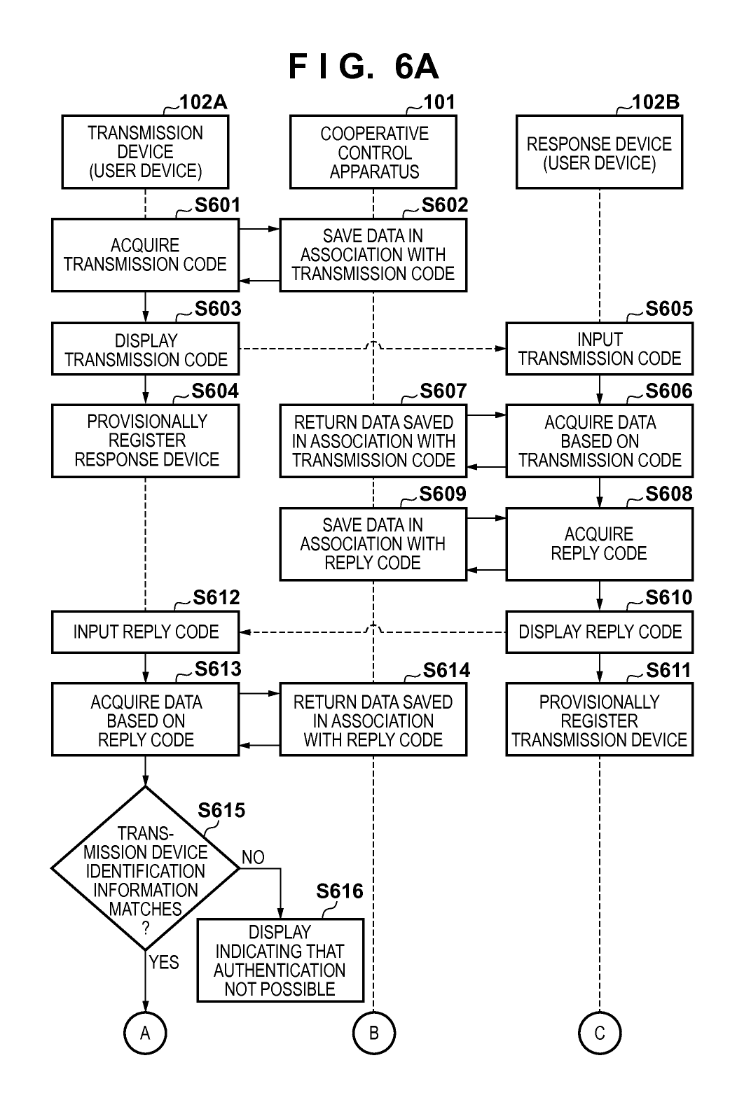

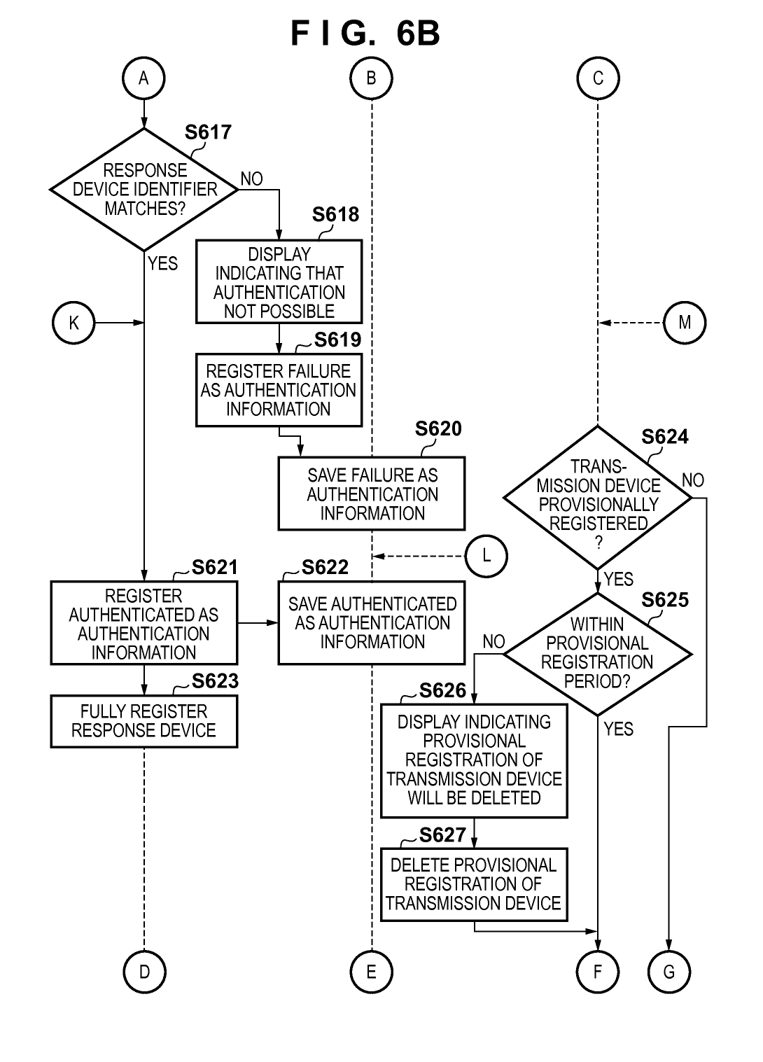

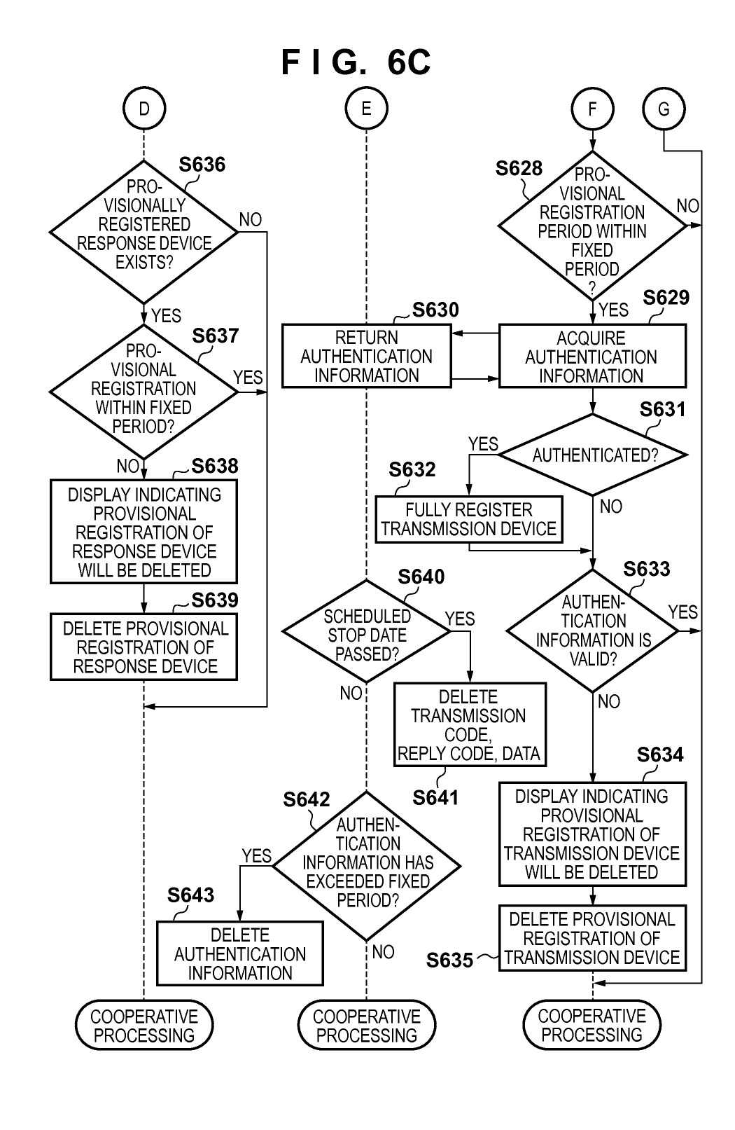

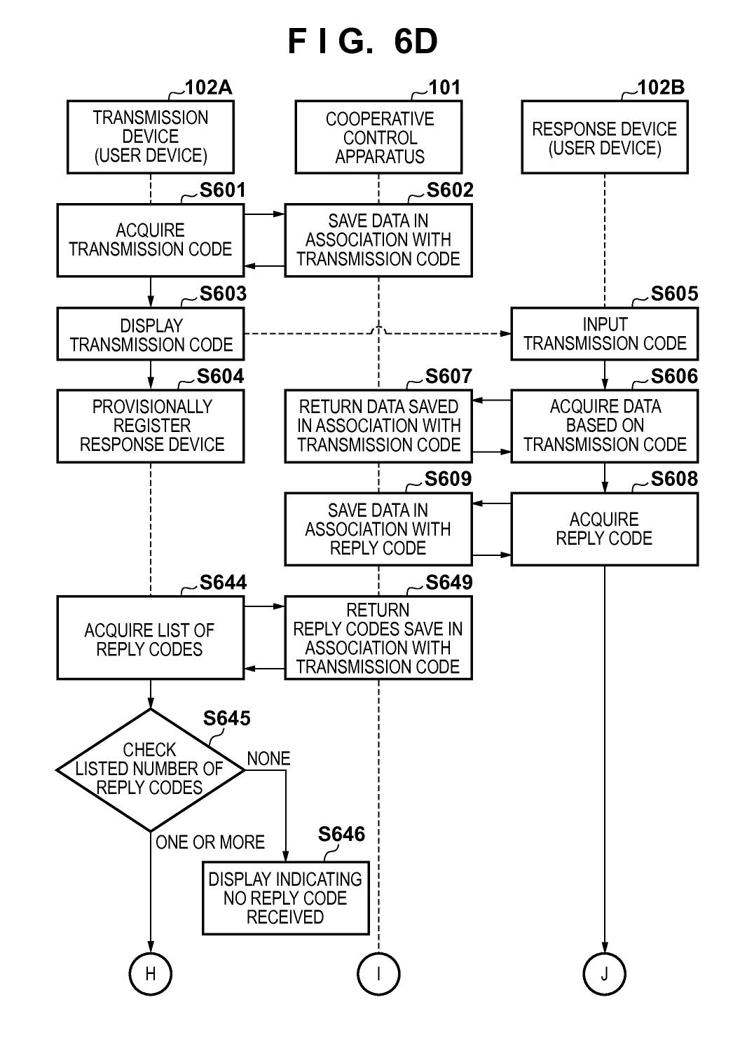

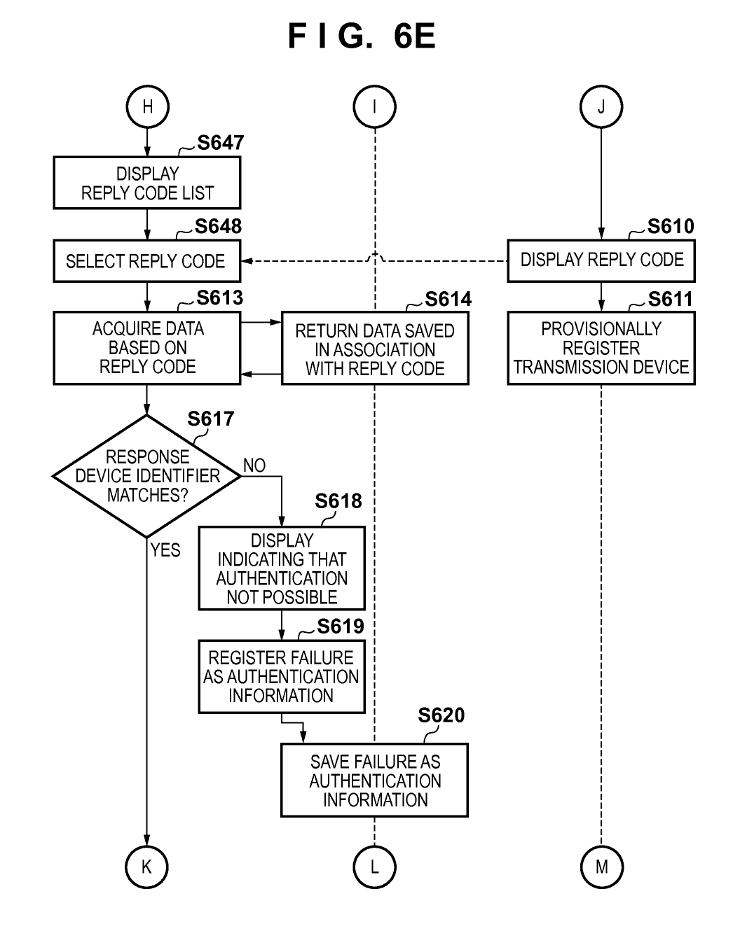

FIGS. 6A to 6C are flowcharts for describing the flow of data in the communication system according to the present embodiment.

First, in step S601, the user device 102A, which is the transmission device, starts processing for generating data for managing a response device.

At this time, in FIG. 4A, the response device cooperation information 403 will not have been set and the status 405 will be “preregistration”, since a reply code has not yet been received from a response device. Also, in FIG. 4B, there is no data for response devices forming a group, and the status 410 is “preregistration”.

In step S601, the user device 102A notifies a request to the cooperative control apparatus 101 for acquisition of a transmission code, with the response device identifier 402 or 408 of the generated data, transmission device identification information indicating the user device 102A, and cooperation information for cooperating. The cooperative control apparatus 101 thereby saves the data notified from the user device 102A in association with the code 201 shown in FIG. 2A as the data (first cooperation information) 202, and sends back the code 201 as a transmission code (step S602).

The user device 102A thereby acquires the transmission code. Next, in step S603, the user device 102A displays the transmission code acquired from the cooperative control apparatus 101 on the display unit 121, as well as notifying the transmission code to the user device 102B. In step S604, the user device 102A then sets the status 405 or 410 of the data generated in step S601 to “provisional registration”. Note that, although not illustrated, the user may, in step S604, be prompted to set the response device name 404 of FIG. 4A or the response device group name 409 of FIG. 4B.

The user device 102B, in step S605, receives the transmission code notified from the transmission device in step S603. Next, in step S606, the user device 102B uses the transmission code received in step S605 to request the cooperative control apparatus 101 for data saved by the cooperative control apparatus 101 in association with the transmission code. The cooperative control apparatus 101, in step S607, thereby uses the transmission code notified from the user device 102B in step S606 to retrieve the data 202 saved in association with the code 201 of FIG. 2A, and transmits the retrieved data to the user device 102B.

The user device 102B thereby acquires the data in step S606, and, in step S608, extracts the response device identifier 402 and transmission device identification information from the acquired data. The user device 102B then notifies a request to the cooperative control apparatus 101 for acquisition of a reply code, with the extracted information, response device identification information and cooperation data for cooperating with the response device.

In step S609, the cooperative control apparatus 101 thereby saves the data notified from the user device 102B in association with the code 201 of FIG. 2A as the data (second cooperation information) 202, and sends back the code 201 as a reply code. The issue date 203 and the scheduled stop date 204 are also registered at this time. In the case of the data configuration of FIG. 2B, the cooperative control apparatus 101, in step S609, extracts the transmission device identification information from the notified data, and sets the extracted information as the transmission device identification information 206. The cooperative control apparatus 101 then generates the reply code 205 which is unique to the transmission device identification information 206 and the cooperative control apparatus 101. The cooperative control apparatus 101 then saves the data notified from the user device 102B in association with the reply code 205 as the data (second cooperation information) 207, and responds with that reply code 205. The issue date 208 and the scheduled stop date 209 are also registered at this time.

With the data configuration of FIG. 2C, the cooperative control apparatus 101, in step S609, extracts the transmission device identification information and the response device identifier from the notified data, and sets the extracted information and identifier as the transmission device identification information 211 and the response device identifier 212.

The cooperative control apparatus 101 then generates the reply code 210 which is unique to the transmission device identification information 211 and the cooperative control apparatus 101. The cooperative control apparatus 101 saves the data notified from the user device 102B in association with the reply code 210 as the data (second cooperation information) 213, and responds with that reply code 210. The issue date 214, the scheduled use date 215 and the scheduled stop date 216 are also registered at this time.

The user device 102B thereby displays the reply code acquired from the cooperative control apparatus 101 on the display unit 121 in step S610, as well as notifying the reply code to the user device 102A. In step S611, the user device 102B then generates the data for managing the transmission device shown in FIG. 5. Here, the transmission device identification information 502 is the identification information of the transmission device that was extracted from the data acquired in step S606, and the transmission device cooperation information 503 is the cooperation information for cooperating with the transmission device that was extracted from the data acquired in step S606. Also, the status 505 will be “provisional registration” because an authentication result has not yet been acquired. Note that, although not illustrated, the user may be prompted in step S611 to set the transmission device name 504 in FIG. 5, or if a transmission device name is included in the data acquired in step S606, that transmission device name may be set.

Next, in step S612, the user device 102A receives the reply code notified from the user device 102B. Next, in step S613, the user device 102A uses the reply code received in step S612 to request the cooperative control apparatus 101 for data saved in association with that reply code. At this time, in the case where the cooperative control apparatus 101 manages the reply code as shown in FIG. 2B or FIG. 2C, the user device 102A uses the reply code 205 or 210 and the transmission device identification information of the user device 102A to request the cooperative control apparatus 101 for data saved in association with that reply code.

In step S614, the cooperative control apparatus 101 thereby retrieves and sends the data 202 saved in association with the code 201 of FIG. 2A, using the reply code sent from the user device 102A in step S613. In the case of the data configuration of FIG. 2B or FIG. 2C, the cooperative control apparatus 101 uses the notified reply code and transmission device identification information to extract the saved data 207 or 213, with reference to the transmission device identification information 206 and the reply code 205 or the transmission device identification information 211 and the reply code 210, and responses with the extracted data 207 or 213. Note that in the case of the data configuration of FIG. 2B or FIG. 2C, the data of the reply code cannot be acquired from the cooperative control apparatus 101 unless the transmission device identification information notified to the user device 102B matches the transmission device identification information of the user device 102A that requested acquisition of the data of the reply code. Cooperating with an unintended device can thereby be prevented.

Next, in step S615, the user device 102A extracts the device identification information indicating the transmission device from the data acquired in step S613, and determines whether the extracted device identification information matches the transmission device identification information of the user device 102A. Here, the processing advances to step S617 (FIG. 6B) when it is determined that the information matches, and advances to step S616 when this is not the case. At this time, in the case where the cooperative control apparatus 101 manages the reply code 205 or the reply code 210 with the data configuration of FIG. 2B or FIG. 2C, comparison with the transmission device identification information 206 or the transmission device identification information 211 of the user device 102A will have already been performed by the cooperative control apparatus 101. Therefore, in the case where data could not be acquired due to the information not matching in step S615, the processing advances to step S616. In step S616, the user device 102A notifies the user that authentication with the reply code was not possible, and ends the processing. Also, if, in the case of the data configuration of FIG. 2A, the transmission device identification information notified with the transmission code to the user device 102B that generated the reply code is not the same as the transmission device identification information of the user device 102A that requested the data of the reply code, the processing advances to step S616. Therefore, cooperating with an unintended device will not occur.

Next, in step S617 (FIG. 6B), the user device 102A extracts the response device identifier from the data acquired in step S613 (FIG. 6A), and checks whether there is data managing a response device whose response device identifier 402 of FIG. 4A matches the extracted response device identifier and whose status 405 is “provisional registration”. The processing advances to step S621 if this data exists, and the processing advances to step S618 if this data does not exist.

At this time, in the case of the data configuration of FIG. 4B, the user device 102A extracts the response device identifier from the data acquired in step S613. The user device 102A then determines whether there is data managing a response device whose response device identifier 408 matches the extracted response device identifier and whose status 410 is “provisional registration” or “registered”. The processing then advances to step S621 if this data exists, and the processing advances to step S618 if this data does not exist. Note that, although not illustrated, in the case where there is data whose response device identifier matches and whose status is unproblematic, the user device 102A displays the response device name 404 or the response device group name 409 of FIG. 4A or 4B. The user may then be prompted to check whether cooperation will be with an intended response device. At this time, if the response device name 404 of FIG. 4A or the response device group name 409 of FIG. 4B is not set, the registration date 406 or the registration date 411 may be used instead.

Also, in the case where a transmission code is notified from a transmission device to each of a plurality of response devices, the transmission code notified from the transmission device could possibly be wrong due to an error in inputting the transmission device when the transmission code is received by a response device. In this case, a response device different from that provisionally registered in step S604 will be registered in the transmission device. The possibility of mistakenly cooperating with a different response device from the provisionally registered response device can thus be reduced, by displaying information on the response device that was provisionally registered in step S604 to the user and enabling the user to check whether the response device is the intended response device.

In step S618, the user device 102A notifies the user that authentication with the reply code was not possible. Next, in step S619, the user device 102A extracts the response device identification information from the data acquired in step S613. The user device 102A then notifies a request to the cooperative control apparatus 101 to set “failure” as authentication information, with the transmission device identification information of the user device 102A and the extracted response device identification information, and ends the processing.

In step S620, the cooperative control apparatus 101 thereby sets “failure” in the status 303 shown in FIG. 3 as authentication information, based on the “failure” setting request of step S619.

Also, when the response device identifiers match in step S617 and it is clear that the response device is the intended device, the processing advances to step S621, where the user device 102A extracts device identification information indicating the response device from the data acquired in step S613. The user device 102A then notifies a request to the cooperative control apparatus 101 to set “authenticated” as authentication information, with the transmission device identification information of the user device 102A and the extracted device identification information.

In step S622, the cooperative control apparatus 101 thereby sets the status 303 shown in FIG. 3 to “authenticated” as authentication information, based on the “authenticated” setting request of step S621.

Next, the user device 102A, in step S623, extracts the response device identifier from the data acquired in step S613, and checks for data managing a response device whose response device identifier 402 of FIG. 4A matches and whose status 405 is “provisional registration”. The user device 102A then sets the cooperation data for cooperating with the response device that was extracted from the acquired data in the response device cooperation information 403 of the corresponding data, sets the status 405 of the corresponding data to “registered”, and ends the processing. The response device will thereby be fully registered as a device with which to perform cooperative processing.

Note that, although not illustrated, in the case where the response device name 404 of FIG. 4A is not set, the user may be prompted to set the response device name 404 in step S623, or if there is a response device name in the data acquired in step S613, that name may be set. Also, in the case of the data configuration of FIG. 4B, the user device 102A generates data for each response device. The response device cooperation information 415 is cooperation data for cooperating with the response device that is extracted from the data acquired in step S613, and the response device name 416 will be information set by the user, or, if there is a response device name in the data acquired in step S613, information resulting from the name being set.

Also, in the case of managing a plurality of response devices, the user device 102A extracts the response device identifier from the data acquired in step S613, and checks for data managing a response device whose response device identifier 408 matches and whose status 410 is “provisional registration” or “registered”. The user device 102A then links the group information of the corresponding response device with the generated information for each response device, sets the status 410 of the corresponding data to “registered”, and ends the processing. Note that, although not illustrated, in the case where the response device group name 409 of FIG. 4B is not set, the user may be prompted to set the response device group name 409 in step S623.

On the other hand, the user device 102B, in step S624 (FIG. 6B), extracts data whose status 505 is “provisional registration” from the management data of the transmission device of FIG. 5, and advances the processing to step S625 if there is corresponding data and ends the processing if there is not corresponding data. In step S625, the user device 102B separates data for which a fixed period has passed since the registration date 506 from data that is within the fixed period based on the corresponding data, and advances the processing to step S626 if there is data for which the fixed period has passed. Also, when there is no data for which the fixed period has passed, the processing advances to step S628 (FIG. 6C). For example, when the fixed period is 14 days, data whose registration date 506 is prior to a date obtained by subtracting 14 days from the current date will be separated from data whose registration date 506 is on or after the date. In step S626, the user device 102B displays the transmission device name 504 of data for which it is determined in step S625 that the fixed period has passed and notifies the user that cooperation with the transmission device was not possible. At this time, if the transmission device name 504 of FIG. 5 is not set, the registration date 506 may be displayed instead. Next, in step S627, the user device 102B deletes the data for which it is determined in step S625 that the fixed period has passed from the management data of FIG. 5. Data for cooperation whose reply code has not been processed by the transmission device is thereby deleted.

The processing then advances to step S628 (FIG. 6C), where the user device 102B checks whether there is data that was determined in step S625 to be within the fixed period, and advances the processing to step S629 if there is data that is within the fixed period, and ends the processing if there is no data that is within the fixed period. In step S629, the user device 102B notifies a request to the cooperative control apparatus 101 to check the authentication information, with the transmission device identification information 502 set in step S611 and the response device identification information of the user device 102B, based on the data that is within the fixed period. The cooperative control apparatus 101, in step S630 (FIG. 6C), thereby uses the transmission device identification information and response device identification information notified from the user device 102B to extract the status 303 saved in association with the transmission device identification information 301 and the response device identification information 302 of FIG. 3, and responds with the extracted status 303.

The user device 102B, in step S631, thereby separates the data separated in step S625 into data that is “authenticated” and data that is not “authenticated”, based on the authentication information acquired in step S629. The processing advances to step S632 if there is “authenticated” data, and advances to step S633 if there is no “authenticated” data. In step S632, the user device 102B sets the status 505 of the “authenticated” data separated in step S631 to “registered”. A transmission device that has received a reply code and been successfully authenticated using the reply code is thereby determined as a device with which to perform cooperative processing. Next, in step S633, the user device 102B separates the data separated in step S625 into data that is “failure” and data that is not “failure”, based on the authentication information acquired in step S629. The processing advances to step S634 if there is “failure” data, and the processing ends if there is no “failure” data. The user device 102B, in step S634, displays the transmission device name 504 of the “failure” data that was separated in step S633, and notifies the user that cooperation was not possible. At this time, if the transmission device name 504 of FIG. 5 is not set, the registration date 506 can be displayed instead. Next, in step S635, the user device 102B deletes the “failure” data separated in step S633 from the transmission device management data, and ends the processing. Cooperation information with which cooperation was not possible due to the response device identifiers not matching when the reply code was processed by the transmission device is thereby deleted.

Next, the user device 102A, in step S636 (FIG. 6C), extracts data whose status 405 is “provisional registration” from the response device management data of FIG. 4A, and advances processing to step S637 if there is corresponding data and ends the processing if there is no corresponding data. Also, in the case of the data configuration of FIG. 4B, the user device 102A extracts data whose response device identifier 408 is set and whose status 410 is “provisional registration” or “registered” from the response device management data. The processing then advances to step S637 if there is corresponding data, and ends if there is no corresponding data.

In step S637, the user device 102A separates data for which a fixed period has passed since the registration date 406 or 411 from data that is within the fixed period based on the corresponding data. The processing then advances to step S638 if there is data for which the fixed period has passed, and ends if there is no data for which the fixed period has passed. For example, when the fixed period is 14 days, data whose registration date 406 or 411 is prior to a date obtained by subtracting 14 days from the current date will be separated from data whose registration date 406 or 411 is on or after that date. In step S638, the user device 102A displays the response device name 404 of the data for which the fixed period has passed that was separated in step S637 and notifies the user that cooperation was not possible. At this time, if the response device name 404 of FIG. 4A is not set, the registration date 406 may be displayed instead. Also, in the case of the data configuration of FIG. 4B, the user device 102A displays the response device group name 409 of the data for which the fixed period has passed in step S637 and notifies the user that cooperation was not possible. At this time, in the case where the status 410 of the data is “registered”, the user may be notified that the period during which cooperation is possible has passed. Also, when the response device group name 409 of FIG. 4B is not set, the registration date 411 may be displayed instead.

In step S639, the user device 102A deletes the data for which it is determined in step S637 that the fixed period has passed from the response device management data, and ends the processing. In the case of the data configuration of FIG. 4B, the user device 102A ends the processing after clearing the response device identifier 408, in the case where the status 410 of the data for which it is determined in step S637 that the fixed period has passed is “registered”. Also, in the case where the status 410 is “provisional registration”, the user device 102A ends the processing after deleting the corresponding data from the management data. Data relating to cooperation whose reply code was not notified from a response device is thereby deleted by the transmission device. Also, in the case where the status 410 is “registered”, this data may be directly used as the group information of the response device because one or more notifications have been received from the response device.

Also, the cooperative control apparatus 101, in step S640, separates data whose scheduled stop date 204, 209 or 216 of FIG. 2A, 2B or 2C is prior to the date of current processing from data whose scheduled stop date is on or after that date. The processing advances to step S641 if there is data that is prior to the date on which processing is being performed, and the processing ends if there is no data that is prior to the date on which processing is being performed. In step S641, the cooperative control apparatus 101 deletes the transmission code and reply code of data that is determined in step S640 to be prior to the date on which processing is being performed, and ends the processing. Generation of the transmission code and reply code can thereby be facilitated.

Also, in step S642, the cooperative control apparatus 101 separates data for which a fixed period has passed since the registration date 304 of FIG. 3 from data that is within the fixed period. The processing advances to step S643 if there is data for which the fixed period has passed, and the processing ends if there is no data for which the fixed period has passed. For example, when the fixed period is 14 days, data whose registration date 304 is prior to a date obtained by subtracting 14 days from the current date will be separated from data whose registration date 304 is on or after that date. In step S643, the cooperative control apparatus 101 deletes the data for which it is determined in step S642 that the fixed period has passed from the management data of the authentication information, and ends the processing. This enables the number of data in the authentication information to be suppressed, although it is also possible to manage all transmission devices and response devices that are cooperating by not executing steps S642 and S643.

As a result of the processing described above, cooperation information is stored in the cooperative control apparatus 101 in association with a transmission code that a transmission device acquires from the cooperative control apparatus 101. A response device uses that transmission code, which is notified from the transmission device, to acquire the cooperation information from the cooperative control apparatus 101, as well as sending information on the response device to the cooperative control apparatus 101 to acquire a reply code, and notifying the reply code to the transmission device. The transmission device thereby uses the reply code to discriminate whether it is a reply code generated based on the transmission code that the transmission device itself transmitted, and whether it is a reply code from the intended response device, and, if this is the case, registers that response device as a response device with which to cooperate.

Also, the cooperative control apparatus 101 stores cooperation data, transmission device identification information, a validity period and the like in association with the issued transmission code and reply code, and stores identification information of the transmission device and the response device that cooperate, the status of the cooperation data, and the like as authentication information. The transmission device can thereby be authenticated when the response device requests authentication of the transmission device.

Note that although the user device 102A, in step S601 for requesting acquisition of a transmission code, notifies the request with cooperation information for cooperating to the cooperative control apparatus 101 in the present embodiment, a configuration may be adopted in which cooperation information for cooperating is notified when setting the authentication information in step S621, and the user device 102B is able to acquire the cooperation information together with the authentication information in step S630. This enables information for cooperating with the user device 102A to only be notified to an authenticated device.

After the transmission device and the response device have thus checked each other, data can be cooperatively processed in accordance with the cooperation information. Also, because a validity period is set for the transmission code and the reply code, cooperative processing is only executed within the set period, and the transmission code and reply code can be used in other cooperative processing after the period has passed.

FIGS. 6D to 6E are flowcharts for describing the data flow in the communication system according to another embodiment of the present invention.

The processing from step S601 to step S611, step S613 to step S614 and step S617 to step S620 is the same as the flowchart previously described with reference to FIGS. 6A and 6B. Note that, in this flowchart, the data configuration of the transmission code and the reply code managed by the cooperative control apparatus 101 is described with reference to FIG. 2B or FIG. 2C.

In step S644 (FIG. 6D), the user device 102A uses the transmission device identification information of the user device 102A to request the cooperative control apparatus 101 for a reply code list saved in association therewith. Note that, although not illustrated here, checking for a reply code from the response device with respect to which step S604 was executed could conceivably be performed by timer or user instruction after execution of step S604 in the following cases. First, checking for a reply code from the response device can be instructed by the user with the status 405 of FIG. 4A in the “provisional registration” state. Also, in the case of FIG. 4B, checking for a reply code from the response device can be instructed by the user regardless of the state of the status 410. Further, rechecking for a reply code from the response device can be performed by timer or user instruction after execution of step S646. Thus, in the case where the response device identifier can be specified, the user device 102A uses the transmission device identification information of the user device 102A and the response device identifier 402 or 408 identifying the response device with respect to which checking of the reply code is instructed to request the cooperative control apparatus 101 for the reply code list saved in association therewith.

In step S649, in the case of the data configuration of FIG. 2B, the cooperative control apparatus 101 thereby uses the received transmission device identification information to extract reply codes 205 saved in association with the transmission device identification information 206, and responds with the extracted reply codes 205.

Also, in the case of the data configuration of FIG. 2C, the cooperative control apparatus 101 uses the received transmission device identification information and response device identifier to extract reply codes 210 saved in association with the transmission device identification information 211 and the response device identifier 212, and responds with the extracted reply codes 210.

Note that in the case of the data configuration of FIG. 2B or FIG. 2C, the reply code list cannot be acquired from the cooperative control apparatus 101 unless the transmission device identification information notified to the user device 102B matches the transmission device identification information of the user device 102A that requested acquisition of the data of the reply code. Cooperating with an unintended device can thereby be prevented.

Also, because the reply codes are narrowed down with the response device identifier notified to the user device 102B in the case of the data configuration of FIG. 2C, the reply codes from a plurality of response devices will not get mixed up in the case of performing cooperation individually with a plurality of response devices at the same time.

In step S645, the user device 102A checks the number of reply code lists received in step S644. The processing advances to step S646 if there is no list, and the processing advances to step S647 (FIG. 6E) when this is not the case.

Note that if there is no reply code list in the case where the request of step S644 was made using transmission device identification information and a response device identifier in the case of the data configuration of FIG. 2C, this indicates that a reply code has not been received from the designated response device.

Also, if there is no reply code list in the case of the data configuration of FIG. 2B or in the case where the request of step S644 was made using only transmission device identification information, this indicates that the transmission device has not received a reply code from a response device.

In step S646, the user device 102A performs display indicating that a reply code has not been received from a response device. The user device 102A rechecks for a reply code or ends the processing in accordance with a user instruction. On the other hand, in step S647 (FIG. 6E), the user device 102A displays the reply code list received in step S644. Next, the processing advances to step S648, where the user device 102A selects the reply code notified from the user device 102B. The processing then advances to S613, where the user device 102A uses the reply code selected in step S648 to request the cooperative control apparatus 101 for data saved in association with that reply code. At this time, in the case where the cooperative control apparatus 101 manages reply codes as shown in FIG. 2B or FIG. 2C, the user device 102A uses the reply code 205 or 210 and the transmission device identification information of the user device 102A to request the cooperative control apparatus 101 for data saved in association with that reply code.

Note that in the case where not only the reply code list but also the data saved in association with the reply codes is acquired as a result of the reply code list request in step S644, there is of course no need to acquire the data of the selected reply code. In step S614 (FIG. 6E), the cooperative control apparatus 101 thereby uses the reply code sent from the user device 102A in step S613, and, in the case of the data configuration of FIG. 2B or FIG. 2C, uses the notified reply code and transmission device identification information to extract the saved data 207 or data 213, with reference to the transmission device identification information 206 and the reply code 205 or the transmission device identification information 211 and the reply code 210, and responds with the extracted data 207 or data 213.

Next, in step S617, the user device 102A extracts the response device identifier from the data acquired in step S613 or step S644, and checks whether there is data managing a response device whose response device identifier 402 of FIG. 4A matches the extracted response device identifier and whose status 405 is “provisional registration”. The processing then advances to step S621 (FIG. 6B) if this data exists, and the processing advances to step S618 if this data does not exist. At this time, if the user device 102A, in step S644, uses transmission device identification information and a response device identifier 402 or 408 identifying a response device to request the cooperative control apparatus 101 for a reply code list saved in association therewith in the case of the data configuration of FIG. 2C, comparison with the transmission device identification information 211 of the user device 102A and the response device identifier 212 will have already performed by the cooperative control apparatus 101. Therefore, the processing of step S621 may of course be performed without performing step S617. The processing from step S618 onward is the same as the flowchart described in FIG. 6B.

As a result of the processing described above, cooperation information is stored in the cooperative control apparatus 101 in association with a transmission code that a transmission device acquires from the cooperative control apparatus 101. A response device uses that transmission code, which is notified from the transmission device, to acquire the cooperation information from the cooperative control apparatus 101, as well as sending information on the response device to the cooperative control apparatus 101 to acquire a reply code, and notifying that reply code to the transmission device. The transmission device thereby uses that reply code to discriminate whether it is a reply code generated based on the transmission code that the transmission device itself transmitted, and whether it is a reply code from the intended response device, and, if this is the case, registers that response device as a response device with which to cooperate.

Also, the cooperative control apparatus 101 stores cooperation data, transmission device identification information, a validity period and the like in association with the issued transmission code and reply code, and stores identification information of the transmission device and the response device that are cooperating, the status of the cooperation data, and the like as authentication information. The transmission device can thereby be authenticated when the response device requests authentication of the transmission device.

Note that although the user device 102A, in step S601 for requesting acquisition of a transmission code, notifies the request with cooperation information for cooperating to the cooperative control apparatus 101 in the present embodiment, a configuration may be adopted in which cooperation information for cooperating is notified when setting the authentication information in step S621, and the user device 102B is able to acquire the cooperation information together with the authentication information in step S630. This enables information for cooperating with the user device 102A to only be notified to an authenticated device.

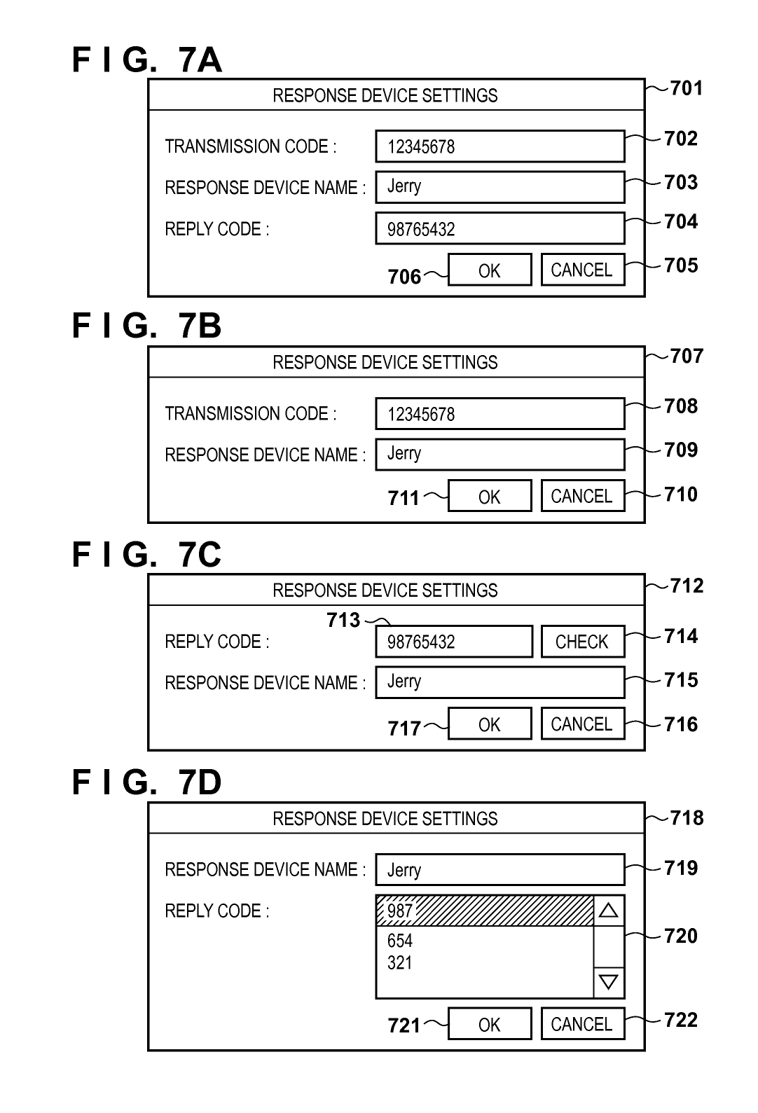

FIG. 7A to FIG. 7C are diagrams showing exemplary screens for setting a response device that are displayed on the transmission device of the present embodiment.

FIG. 7A is a response device setting screen for displaying and notifying a transmission code to the user and enabling the name of the response device and the reply code to be set on the transmission device.

Reference numeral 701 denotes the response device setting screen of the transmission device. Reference numeral 702 denotes a transmission code acquired by the transmission device. Reference numeral 703 denotes an area for setting the name of a response device on the transmission device. Reference numeral 704 denotes an area for setting a reply code notified from the response device to the transmission device. Reference numeral 705 is a CANCEL button for cancelling response device setting on the transmission device. Reference numeral 706 denotes an OK button for executing response device setting on the transmission device.

FIG. 7B shows a response device setting screen for displaying and notifying a transmission code to the user on the transmission device.

Reference numeral 707 is the response device setting screen for displaying a transmission code on the transmission device. Reference numeral 708 denotes a transmission code acquired by the transmission device. Reference numeral 709 denotes an area for setting the name of a response device on the transmission device. Reference numeral 710 denotes a CANCEL button for cancelling response device setting on the transmission device. Reference numeral 711 denotes an OK button for executing response device setting on the transmission device. When the OK button 711 is instructed on the transmission device, the response device name is stored in association with the response device identifier, as shown in FIGS. 4A and 4B. At this time, in the case of browser display where the transmission device is a server, response device identifiers and response device names may be held in a session, cookie, database or the like.

FIG. 7C is a response device setting screen for setting and authenticating a reply code on the transmission device.

Reference numeral 712 is the response device setting screen for setting and authenticating a reply code on the transmission device. Reference numeral 713 denotes an area for setting a reply code notified to the transmission device from a response device. Reference numeral 714 denotes a CHECK button for checking the reply code set on the transmission device. When the CHECK button 714 is instructed on the transmission device, the transmission device identification information and response device identifier are checked, and a response device name associated with the response device identifier is displayed, as shown in the flowcharts of FIGS. 6A to 6C. Reference numeral 715 is the response device name that is associated with the response device identifier, when the CHECK button 714 is pressed on the transmission device. Reference numeral 716 denotes a CANCEL button for cancelling response device setting on the transmission device. Reference numeral 717 denotes an OK button for executing response device setting on the transmission device. By thus displaying the response device name associated with the response device identifier, cooperating with a different response device from the provisionally registered response device can be prevented. Note that in the case of browser display where the transmission device is a server, by holding response device identifiers and response device names in a database, FIG. 7C may be executed several days after FIG. 7B without any problem.

FIG. 7D is a response device setting screen for listing and authenticating reply codes on the transmission device.

Reference numeral 718 is the response device setting screen for listing and authenticating reply codes on the transmission device. Reference numeral 719 is a response device name associated with the response device identifier. Reference numeral 720 is an area for displaying a reply code list associated with the transmission device identification information and response device identifiers, as shown in the flowcharts of FIGS. 6D to 6E. Note that if there is only one reply code, this reply code will of course be selected. Reference numeral 722 denotes a CANCEL button for cancelling response device setting on the transmission device. Reference numeral 721 denotes an OK button for executing response device setting on the transmission device.

By thus displaying the reply code list associated with the transmission device identification information and response device identifiers, not only can reply code input errors be prevented but setting of reply codes can also be facilitated.

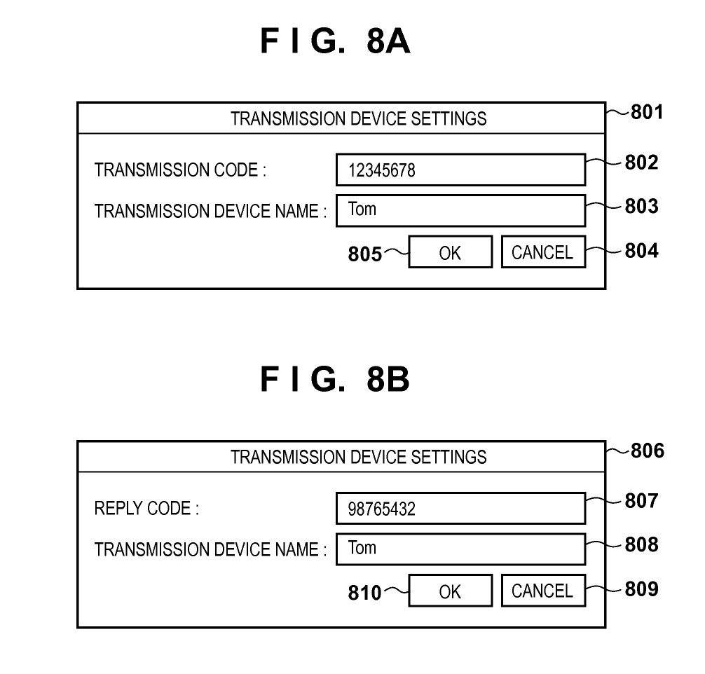

FIG. 8A and FIG. 8B are diagrams showing exemplary screens for setting a transmission device in a response device according to the present embodiment.

FIG. 8A shows an exemplary transmission device setting screen for enabling a transmission code and a transmission device name to be set on a response device.

Reference numeral 801 is the transmission device setting screen for enabling a transmission code and a transmission device name to be set on the response device. Reference numeral 802 denotes an area for setting a transmission code notified from a transmission device to the response device. Reference numeral 803 denotes an area for setting the name of the transmission device on the response device. Reference numeral 804 denotes a CANCEL button for cancelling transmission device setting on the response device. Reference numeral 805 denotes an OK button for executing transmission device setting on the response device. When the OK button 805 is pressed on the response device, the transmission device setting screen shown in FIG. 8B for displaying the reply code will be displayed.

FIG. 8B shows an exemplary transmission device setting screen for displaying a reply code on the response device.

Reference numeral 806 is the transmission device setting screen for displaying the reply code on the response device. Reference numeral 807 denotes the reply code of the response device. Reference numeral 808 denotes the name of the transmission device set in FIG. 8A. Reference numeral 809 denotes a CANCEL button for cancelling transmission device setting on the response device. Reference numeral 810 denotes an OK button for executing transmission device setting on the response device.

By thus using the response device setting screens shown in FIG. 7A to FIG. 7D, and the transmission device setting screens shown in FIG. 8A and FIG. 8B, information for performing cooperation with a device in a remote location can be notified to the remote device.

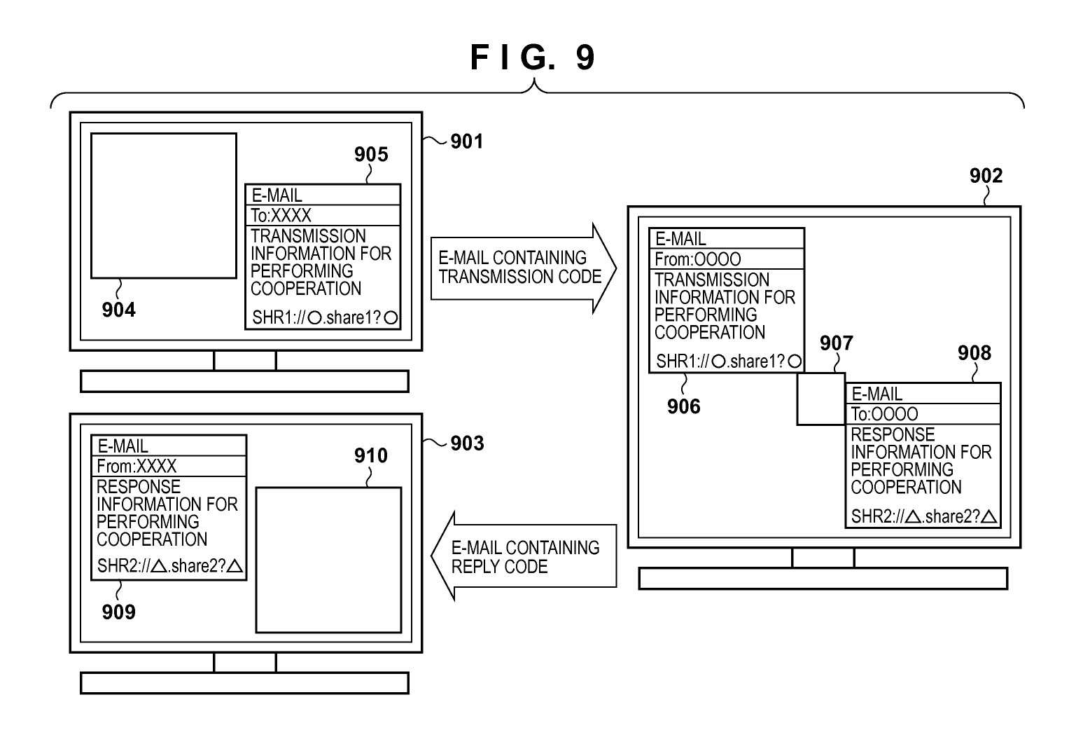

FIG. 9 is a diagram showing exemplary cooperative processing that utilizes e-mail in the communication system according to the present embodiment.

Reference numeral 901 is a screen for sending a transmission code by e-mail on a transmission device. Reference numeral 902 is a screen for receiving a transmission code by e-mail and sending a reply code by e-mail on a response device. Reference numeral 903 is a screen for receiving a reply code by e-mail and processing the received reply code on the transmission device. Reference numeral 904 denotes the screen of a program for performing cooperation on the transmission device. Reference numeral 905 denotes the screen of an e-mail for setting the address and the body containing the transmission code to be sent by e-mail from the program for performing cooperation on the transmission device.

When cooperative processing is instructed in the program for performing cooperation on the transmission device, a transmission code is acquired as shown in the flowcharts of FIGS. 6A to 6C, and the user is prompted to configure the send settings of the e-mail containing the acquired transmission code in the e-mail body as shown on the screen 905.

At this time, a keyword registered in the response device in association with the program is added to the transmission code with an extension or URL scheme, so that the mailer that receives the e-mail is able to execute the program for performing cooperation. For example, with a URL scheme, the keyword is registered so as to run an HTML browser in compliance with HTTP. Therefore, an HTML browser is run when an URL having the keyword “HTTP://” attached is referred to, enabling HTML contents shown by the URL to be referred to. By registering a unique URL scheme in a device utilizing this structure, a registered program can be executed with the same operation as for referring to an URL.

Reference numeral 906 denotes an e-mail reception screen on which an e-mail sent by the transmission device has been received by the response device. Reference numeral 907 denotes the screen of a program for performing cooperation on the response device that is executed with reference to the keyword added so as to enable the program included in the body of the received e-mail to be executed. By thus sending a transmission code having a keyword added thereto from a transmission device by e-mail, the user does not have to input the transmission code.

Reference numeral 908 denotes the screen of an e-mail for setting the address and the body containing the reply code to be sent by e-mail from the program for performing cooperation on the response device. When the program for performing cooperation is executed on the response device with reference to the transmission code having the keyword added thereto, a reply code is acquired as shown in the flowcharts of FIGS. 6A to 6C. The user is prompted to configure the send settings of the e-mail that contains the reply code thus acquired in the e-mail body as shown on the screen 908. At this time, a keyword registered in association with the program is added to the reply code with an extension or URL scheme, so that the mailer that receives that e-mail is able to execute the program for performing cooperation. Reference numeral 909 denotes an e-mail reception screen on which the transmission device has received the e-mail from the response device. Reference numeral 910 denotes the screen of the program for performing cooperation on the transmission device that is contained in the body of the received e-mail and is executed with reference to the reply code having the aforementioned keyword added thereto. By thus sending a reply code having a keyword added thereto from a response device to a transmission device by e-mail, the user of the transmission device does not have to input the reply code.

Note that rather than acquiring a transmission code and a reply code from the cooperative control apparatus (server) 101, the data for cooperative processing can also be directly used instead of a transmission code and a reply code. However, there is a problem in that the data for cooperation has to be able to be represented with characters that can be utilized in the body, and also the increased number of characters because of the increased data volume could result in some mailers inserting a linefeed, preventing the program from being executed by reference. The present embodiment in which a transmission code and a reply code are acquired from the cooperative control apparatus (server) 101 is thus suitable, even in the case of utilizing e-mail to performing cooperation.

### Other Embodiments

Aspects of the present invention can also be realized by a computer of a system or device (or devices such as a CPU or MPU) that reads out and executes a program recorded on a storage device to perform the functions of the above-described embodiments, and by a method, the steps of that are performed by a computer of a system or device by, for example, reading out and executing a program recorded on a storage device to perform the functions of the above-described embodiments. For this purpose, the program is provided to the computer for example via a network or from a recording medium of various types serving as the storage device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application Nos. 2011-057093, filed Mar. 15, 2011, and 2012-034535, filed Feb. 20, 2012, which are hereby incorporated by reference herein in their entirety.

What is claimed is:

1. A communication system comprising a transmission device, a response device and a cooperative control apparatus for controlling cooperative processing between the transmission device and the response device,
wherein the transmission device comprising:
a storage unit configured to store response device information related to cooperative processing with the transmission device;
a first register unit configured to register, in the cooperative control apparatus along with a transmission code relating to the cooperative processing, first cooperation information relating to the cooperative processing;
a notification unit configured to notify the transmission code to the response device;
a first acquisition unit configured to acquire, from the cooperative control apparatus, second cooperation information associated with a reply code received from the response device; and
a first setting unit configured to set the response device specified by response device identification information included in the second cooperation information as a device with which to perform the cooperative processing, in a case where the response device identification information included in the second cooperation information corresponds to the response device information stored in the storage unit, and
wherein the response device comprising:
a second acquisition unit configured to acquire, from the cooperative control apparatus, the first cooperation information associated with the transmission code;
a second register unit configured to register, in the cooperative control apparatus along with the reply code relating to the cooperative processing, the second cooperation information relating to the cooperative processing; and
a second setting unit configured to request the cooperative control apparatus to authenticate the transmission device specified by the first cooperation information, and, if successfully authenticated, sets the transmission device specified by the first cooperation information as a device with which to perform the cooperative processing.

2. The communication system according to claim 1, wherein the cooperative control apparatus has, as information for the authentication, transmission device identification information, response device identification information, and information indicating an authentication result.

3. The communication system according to claim 1, wherein the storage unit stores response device identification information related to the cooperative processing, information indicating whether the response device identification information is provisionally registered or fully registered, and a registration date.

4. The communication system according to claim 1, wherein the response device has, as data for managing the transmission device, transmission device identification information and information indicating whether the transmission device identification information is provisionally registered or fully registered.

5. The communication system according to claim 1, wherein the transmission device acquires the transmission code by requesting the cooperative control apparatus.

6. The communication system according to claim 1, wherein the response device acquires the reply code by requesting the cooperative control apparatus.

7. The communication system according to claim 1, wherein the transmission device includes:
a unit configured to acquire, from the cooperative control apparatus, a reply code list registered in relation to the transmission code from the response device; and
a unit configured to display and select from the reply code list.

8. The communication system according to claim 1, wherein the cooperative control apparatus including:
a unit configured to register transmission device identification information and the first cooperation information from the transmission device in correspondence with the transmission code;
a unit configured to notify the transmission device identification information and the first cooperation information to the response device in response to a request for the transmission device identification information and the first cooperation information based on the transmission code from the response device;
a unit configured to receive the transmission device identification information and the second cooperation information from the response device, generate the reply code associated with the transmission device identification information and the second cooperation information, and notify the reply code to the response device; and
a unit configured to receive the reply code from the transmission device, and notify the corresponding transmission device identification information and second cooperation information to the transmission device.

9. The communication system according to claim 1, wherein the storage unit notifies one transmission code to a plurality of response devices, and stores information for managing the plurality of response devices as a group.

10. A method of controlling a communication system that includes a transmission device, a response device and a cooperative control apparatus for controlling cooperative processing between the transmission device and the response device, the method comprising:
registering, for the transmission device, in the cooperative control apparatus along with a transmission code relating to the cooperative processing, first cooperation information relating to the cooperative processing;
notifying, for the transmission device, the transmission code to the response device;
acquiring, for the transmission device, from the cooperative control apparatus, second cooperation information associated with a reply code received from the response device;
setting, for the transmission device, the response device specified by response device identification information included in the second cooperation information as a device with which to perform the cooperative processing, in a case where the response device identification information included in the second cooperation information corresponds to response device information stored in the transmission device;
acquiring, for the response device, from the cooperative control apparatus, the first cooperation information associated with the transmission code;
registering, for the response device, in the cooperative control apparatus along with the reply code relating to the cooperative processing, the second cooperation information relating to the cooperative processing; and
requesting, for the response device, the cooperative control apparatus to authenticate the transmission device specified by the first cooperation information, and, if successfully authenticated, setting the transmission device specified by the first cooperation information as a device with which to perform the cooperative processing.
